(19) United States
(12) Patent Application Publication
(10) Pub. No.: US 2026/0276603 A1
(43) Pub. Date: Sep. 17, 2026

(54) ULTRASONIC SENSOR FOR IDENTIFYING MATERIAL OF OBJECT AND OPERATING METHOD THEREOF

(71) Applicant: Gwanak Analog CO., LTD., Seoul (KR)

(72) Inventors: Kyoungwon LIM, Seoul (KR); Sangyou LEE, Seoul (KR); Yiho LEE, Seoul (KR); Kyuseok KIM, Seoul (KR); Woojin KIM, Seoul (KR)

(73) Assignee: Gwanak Analog CO., LTD., Seoul (KR)

(21) Appl. No.: 19/680,430

(22) Filed: May 18, 2026

Related U.S. Application Data
(63) Continuation of application No. PCT/KR2025/006732, filed on May 19, 2025.

(30) Foreign Application Priority Data
Jun. 4, 2024 (KR) 10-2024-0073332

(51) Int. Cl. G01N 29/44

(52) U.S. Cl. CPC G01N 29/44

(57) ABSTRACT

An ultrasonic sensor includes an ultrasonic transmitter transmitting ultrasonic waves toward an object according to a control signal; an ultrasonic receiver receiving a plurality of reflected waves generated by being reflected from a surface of the object; and a control circuit controlling the ultrasonic transmitter and the ultrasonic receiver, wherein the control circuit identifies a material of the object using amplitudes and arrival times of the plurality of reflected waves.

### CROSS-REFERENCE TO RELATED APPLICATIONS

The present application is a continuation of and claims priority to PCT application No. PCT/KR2025/006732, filed on May 19, 2025, which claims priority under 35 U.S.C. § 119 (a) to Korean Patent Application No. 10-2024-0073332, filed on Jun. 4, 2024, the entire contents of which applications are incorporated herein by reference.

### BACKGROUND

### 1. Technical Field

Embodiments relate to an ultrasonic sensor capable of identifying a material of an object and an operating method thereof.

### 2. Related Art

An ultrasonic sensor includes a transducer that transmits ultrasonic waves and receives ultrasonic waves to convert them into electrical signals.

Since the speed of sound is a known value, a distance to an object can be measured by measuring a time from transmission of an ultrasonic wave to reception of the ultrasonic wave reflected from the object.

However, there is a problem in that it is impossible to identify a material of an object by merely measuring the time until a reflected wave is received.

### SUMMARY

In accordance with an embodiment of the present disclosure, an ultrasonic sensor may include an ultrasonic transmitter transmitting ultrasonic waves toward an object according to a control signal; an ultrasonic receiver receiving a plurality of reflected waves generated by being reflected from a surface of the object; and a control circuit controlling the ultrasonic transmitter and the ultrasonic receiver, wherein the control circuit identifies a material of the object using amplitudes and arrival times of the plurality of reflected waves.

In accordance with an embodiment of the present disclosure, an operating method of an ultrasonic sensor including an ultrasonic transmitter transmitting ultrasonic waves toward an object according to a control signal and an ultrasonic receiver receiving a plurality of reflected waves generated by being reflected from a surface of the object, the operating method comprising, the operating method may include measuring amplitudes of the plurality of reflected waves at the ultrasonic receiver; calculating moving distances of the plurality of reflected waves according to arrival times of the plurality of reflected waves; calculating a reflectance according to the amplitudes of the plurality of reflected waves and the moving distances of the plurality of reflected waves; and determining a material of the object according to the reflectance.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments that include various features, and explain various principles and beneficial aspects of those embodiments.

FIG. 1 is a block diagram illustrating an ultrasonic sensor according to an embodiment of the present disclosure.

FIGS. 2A and 2B are explanatory views illustrating a reflection phenomenon of ultrasonic waves between an ultrasonic sensor and an object according to an embodiment of the present disclosure.

FIGS. 3 and 4 are graphs illustrating the amplitude of reflected waves received by an ultrasonic sensor according to an embodiment of the present disclosure.

FIG. 5 is a flowchart illustrating an operation of an ultrasonic sensor according to an embodiment of the present disclosure.

### DETAILED DESCRIPTION

Various embodiments will be described below with reference to the accompanying figures. Embodiments are provided for illustrative purposes and other embodiments that are not explicitly illustrated or described are possible. Further, modifications can be made to embodiments of the present disclosure that will be described below in detail.

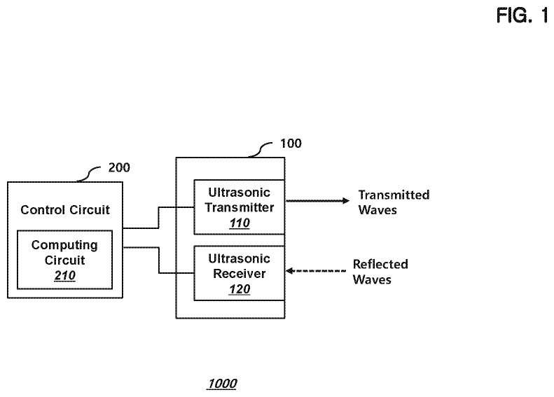

FIG. 1 is a block diagram illustrating an ultrasonic sensor 1000 according to an embodiment of the present disclosure.

The ultrasonic sensor 1000 includes an ultrasonic transducer 100 and a control circuit 200.

The ultrasonic transducer 100 includes an ultrasonic transmitter 110 and an ultrasonic receiver 120.

Since the ultrasonic transmitter 110 and the ultrasonic receiver 120 themselves are well known to those skilled in the art, detailed disclosure thereof will be omitted.

In the present embodiment, the ultrasonic transmitter 110 and the ultrasonic receiver 120 are implemented as one module sharing a circuit board.

In another embodiment, the ultrasonic transmitter 110 and the ultrasonic receiver 120 may be implemented as independent modules that do not share a circuit board, and various other design changes may be possible.

The control circuit 200 controls operations of the ultrasonic transducer 100 to perform operations such as measuring a distance to an object and identifying a material of the object.

The control circuit 200 may control the ultrasonic transmitter 110 to transmit ultrasonic waves using a control signal. Hereinafter, the ultrasonic waves transmitted from the ultrasonic transmitter 110 are referred to as transmitted waves.

The control circuit 200 may control the ultrasonic receiver 120 to measure the amplitude of ultrasonic waves received by the ultrasonic receiver 120 together with an elapsed time after the transmission of the ultrasonic waves. Hereinafter, the ultrasonic waves received by the ultrasonic receiver 120 are referred to as reflected waves.

The control circuit 200 may perform an operation of measuring a distance to an object to be measured and an operation of identifying a material of the object by using information on the amplitude and reception time of the reflected waves received by the ultrasonic receiver 120.

The control circuit 200 may include a computing circuit 210 that performs calculations during the distance measurement or material identification operations. The computing circuit 210 may perform mathematical operations and logical operations.

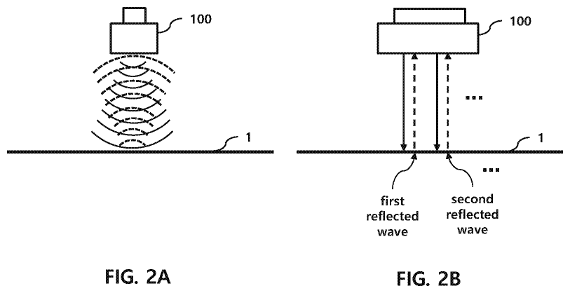

FIGS. 2A and 2B are explanatory views illustrating a reflection phenomenon of ultrasonic waves between an ultrasonic sensor and an object according to an embodiment of the present disclosure.

In FIGS. 2A and 2B, transmitted waves are indicated by solid lines, and reflected waves are indicated by dotted lines.

In FIG. 2A, a plurality of solid lines represent transmitted waves in a wave form, and a plurality of dotted lines represent reflected waves in a wave form.

FIG. 2B illustrates a reflection phenomenon of ultrasonic waves between the ultrasonic transducer 100 and a surface 1 of an object. Hereinafter, the surface 1 of the object may be briefly referred to as an object 1.

First transmitted waves initially transmitted from the ultrasonic transducer 100 are reflected from the object 1 to generate first reflected waves.

The first reflected waves are reflected again from the surface of the ultrasonic transducer 100 to generate second transmitted waves.

The second transmitted waves are reflected again from the object 1 to generate second reflected waves.

Such a phenomenon continues until the amplitude of the ultrasonic waves decreases to a negligible level.

The ultrasonic receiver 120 detects peaks of reflected waves, and sequentially detects a plurality of reflected waves generated according to an echo phenomenon.

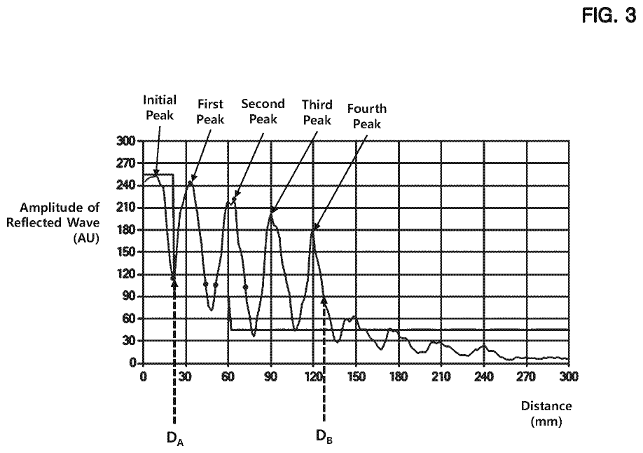

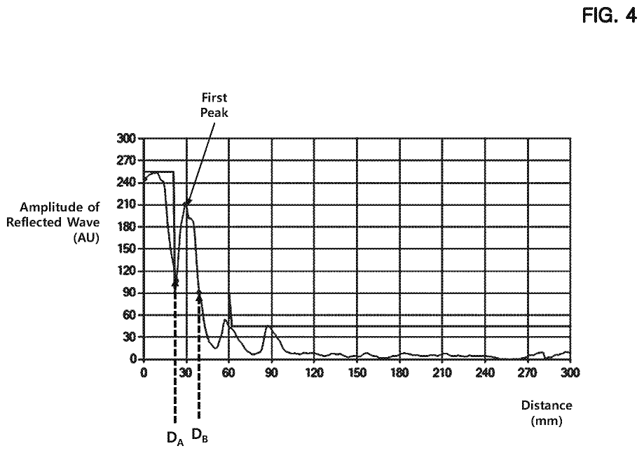

FIGS. 3 and 4 are graphs illustrating the amplitude of reflected waves measured by the ultrasonic sensor 1000 according to an embodiment of the present disclosure.

FIG. 3 corresponds to a case where the object 1 is a hard material, and FIG. 4 corresponds to a case where the object 1 is a soft material.

The horizontal axis of the graph represents an elapsed time converted into a distance, which is expressed by a relational expression of (distance)=(elapsed time)×(speed of sound)/2. At this time, the speed of sound is assumed to be 340 m/s.

In the graph, a time between adjacent peaks corresponds to a time taken for a sound wave to travel back and forth between the ultrasonic sensor 1000 and the object 1. Applying the above relational expression, a distance of 30 mm between adjacent peaks in the graph corresponds to a gap between the ultrasonic sensor 1000 and the object 1.

The vertical axis of the graph represents the amplitude of the reflected wave in arbitrary units (AU).

In FIG. 3, an initial peak indicates that a maximum signal is received by the ultrasonic receiver 120 due to an electrical and mechanical resonance phenomenon between the ultrasonic transmitter 110 and the ultrasonic receiver 120 immediately after the first transmitted waves are generated.

That is, since the initial peak is not received after the first transmitted waves are reflected from the object 1, it is not used for measuring the distance between the ultrasonic sensor 1000 and the object 1.

In FIG. 3, a first peak corresponds to a time point when the first reflected wave is received, a second peak corresponds to a time point when the second reflected wave is received, a third peak corresponds to a time point when a third reflected wave is received, and a fourth peak corresponds to a time point when a fourth reflected wave is received.

Thereafter, subsequent reflected waves are received and corresponding peaks occur.

In the present embodiment, in a process of determining a reflectance, a peak smaller than a peak threshold is ignored.

In FIGS. 3 and 4, it is assumed that the peak threshold is set to 90 and peaks smaller than 90 are ignored.

Details related to the determination of the reflectance will be disclosed again in detail below.

The graph of FIG. 3 corresponds to an object of a hard material.

In FIG. 3, a reception start point is indicated by DA and a reception end point is indicated by DB.

An interval between 0 and DA is an interval including the initial peak, and as described above, is an interval in which a signal is received by the ultrasonic receiver 120 due to a resonance phenomenon between the ultrasonic transmitter 110 and the ultrasonic receiver 120 immediately after the first transmitted waves are generated.

Hereinafter, the interval between 0 and DA may be referred to as a resonance interval.

When the distance between the ultrasonic sensor 1000 and the object 1 is shorter than the resonance interval, it is difficult to measure the distance to the object 1.

It can be considered that the first reflected wave starts to be received after the DA point where the amplitude of the reflected wave gradually increases. A point where the amplitude of the first reflected wave is maximum is indicated as the first peak.

Thereafter, as the second reflected wave, the third reflected wave, and the fourth reflected wave are received, the second peak, the third peak, and the fourth peak sequentially occur.

When the peak threshold is set to 90, the reception end point corresponds to DB. After the reception end point, a peak exceeding the peak threshold does not occur.

Hereinafter, an interval between DA and DB may be referred to as a reflected wave reception interval.

By integrating the amplitude of sound waves received during the reflected wave reception interval, total energy of the reflected waves can be measured.

The graph of FIG. 4 corresponds to an object 1 of a soft material.

In the graph of FIG. 4, since peaks lower than the peak threshold exist, the distance between the peaks can be measured.

However, in the graph of FIG. 4, the reflected wave reception interval is significantly reduced compared to FIG. 3, indicating that only the first peak exists within the reflected wave reception interval.

In free space, it is known that the amplitude of an ultrasonic signal decreases in proportion to the square of a moving distance.

It is known that when ultrasonic waves hit a rough surface or an object smaller than a wavelength, a scattering effect occurs where reflected waves scatter in all directions, and the scattering effect is known to be proportional to the fourth power of frequency.

In addition, it is known that when ultrasonic waves pass through an interface between two media having different refractive indices, a part thereof is refracted and absorbed.

Unlike hard objects such as floorboards, soft fibrous objects such as carpets have a higher sound wave absorption rate and are characterized by more scattering on the surface.

Accordingly, the reflectance tends to be significantly reduced on the surface of a soft object compared to the surface of a hard object.

In consideration of this point, in the present technology, the material of an object is identified using a reflectance as defined by Equation 1 below.

$$R = \frac{a}{{G}_{RX}} \times {\int }_{{D}_{A}}^{{D}_{B}} \frac{{P}_{r} ( x )}{{P}_{TX}} dx \qquad [ Equation 1 ]$$

In Equation 1, a is a proportional constant, G_{RX} represents a gain of the ultrasonic receiver 120, P_{TX} represents energy used to transmit ultrasonic waves from the ultrasonic transmitter 110, and Pᵣ (x) represents energy of a reflected wave at a point x. An integration interval may be limited to the above-described reflected wave reception interval.

The reflectance of ultrasonic waves is not only affected by the material of an object, but may vary due to various reasons such as an angle between the ultrasonic sensor 1000 and the surface of the object and a relative moving speed.

Accordingly, in the present embodiment, a modified reflectance R_{M} of Equation 2 is used instead of the physical reflectance of Equation 1.

Hereinafter, the modified reflectance R_{M} is referred to as a reflectance.

In the present embodiment, the reflectance (RM) considers both the amplitude of the reflected wave received by the ultrasonic receiver 120 and a moving distance of the reflected wave.

At this time, the amplitude and moving distance of the reflected wave are based on peaks.

$${R}_{M} = v \times ( {\sum }_{i = 1}^{N} {V}_{i} {D}_{i}^{2} ) \qquad [ Equation 22 ]$$

In Equation 2, v represents a proportional constant, Vᵢ represents an output amplitude of the ultrasonic receiver 120 corresponding to an i-th peak, and Dᵢ represents a total moving distance of a reflected wave corresponding to the i-th peak.

In addition, N is determined according to the number of peaks having a value greater than or equal to the peak threshold. Assuming that the peak threshold is 90, N=4 in the case of FIG. 3 and N=1 in the case of FIG. 4.

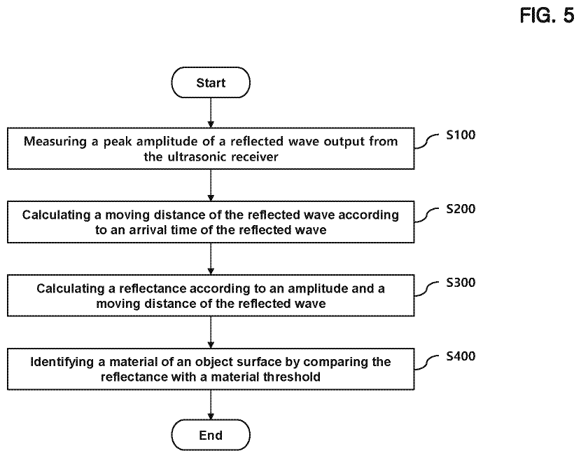

FIG. 5 is a flowchart illustrating an operation of the ultrasonic sensor 1000 according to an embodiment of the present disclosure. First, a peak amplitude of a reflected wave received by the ultrasonic receiver 120 is measured at S100.

A peak amplitude of a reflected wave corresponding to an i-th peak, that is, an i-th reflected wave, corresponds to the Vᵢ value in Equation 2.

In the case of FIG. 3, it corresponds to V₁=240, V₂=215, V₃=200, V₄=180, and in the case of FIG. 4, it corresponds to V₁=210.

Next, a moving distance of the reflected wave is calculated according to an arrival time of the reflected wave at S200.

At this time, a total moving distance Dᵢ of a reflected wave corresponding to the i-th peak, that is, the i-th reflected wave, represents a distance moved by the ultrasonic wave until the i-th peak occurs after the first transmission of the ultrasonic wave.

As described above, the distance between the ultrasonic sensor 1000 and the object 1 in FIGS. 3 and 4 is 30 mm.

Therefore, in the case of FIG. 3, it corresponds to D₁=60 mm, D₂=120 mm, D₃=180 mm, D₄=240 mm, and in the case of FIG. 4, it corresponds to D₁=60 mm.

Next, a reflectance is calculated according to the amplitude Vᵢ and moving distance Dᵢ of the reflected wave at S300.

Equation 2 calculates the reflectance by accumulating values obtained by multiplying the amplitude of each peak Vᵢ located within the reflected wave reception interval by the square of the total moving distance Dᵢ of the peak.

In Equation 2, the proportional constant v is a combination of factors that have a constant influence each time the reflectance is measured.

For example, factors such as a, G_{RX}, and P_{TX} in Equation 1 are components that do not change and are maintained at constant values each time the reflectance is measured.

The proportional constant v in Equation 2 is a combination of these and may be adjusted according to embodiments. For example, the proportional constant v may be set such that the reflectance of Equation 2 becomes a value in a certain range that does not cause overflow or underflow.

Next, the material of the object surface is identified by comparing the calculated reflectance with a material threshold at S400.

When the reflectance is greater than or equal to a predetermined material threshold, the material of the object may be determined to be a hard material, and when the reflectance is smaller than the predetermined material threshold, the material of the object may be determined to be a soft material.

At this time, the hard material may be referred to as a first material, and the soft material may be referred to as a second material.

In order to determine the material threshold, experiments are performed using various hard objects and various soft objects, and after determining graphs such as those in FIGS. 3 and 4 for each case, a reflectance such as Equation 2 can be calculated for each.

The material threshold may be determined in consideration of a statistical distribution of reflectances corresponding to hard objects and a statistical distribution of reflectances corresponding to soft objects calculated as a result of the experiments.

For example, an average value of reflectances corresponding to hard objects and an average value of reflectances corresponding to soft objects may be calculated, and a median value thereof may be determined as the material threshold.

Since an experimental method for pre-determining the material threshold can be variously changed by those skilled in the art, additional disclosure thereof will be omitted.

Although various embodiments have been described for illustrative purposes, it will be apparent to those skilled in the art that various changes and modifications may be made to the described embodiments without departing from the spirit and scope of the disclosure as defined by the following claims.

What is claimed is:

1. An ultrasonic sensor comprising:
an ultrasonic transmitter transmitting ultrasonic waves toward an object according to a control signal;
an ultrasonic receiver receiving a plurality of reflected waves generated by being reflected from a surface of the object; and
a control circuit controlling the ultrasonic transmitter and the ultrasonic receiver,
wherein the control circuit identifies a material of the object using amplitudes and arrival times of the plurality of reflected waves.

2. The ultrasonic sensor of claim 1, wherein the control circuit calculates an i-th partial product, which is a product of an amplitude of an i-th peak among a plurality of peaks corresponding to the plurality of reflected waves and a square of a moving distance of the i-th peak, and calculates a reflectance by accumulating a plurality of partial products corresponding to the plurality of peaks, wherein the moving distance of the i-th peak is (2i)×(a distance between the ultrasonic sensor and the object), wherein i is a natural number.

3. The ultrasonic sensor of claim 2, wherein the plurality of peaks have values greater than or equal to a predetermined peak threshold.

4. The ultrasonic sensor of claim 2, wherein when the reflectance is greater than or equal to a predetermined material threshold, the control circuit determines the material of the object to be a first material, and when the reflectance is smaller than the predetermined material threshold, the control circuit determines the material of the object to be a second material, wherein the first material is a harder material than the second material.

5. An operating method of an ultrasonic sensor including an ultrasonic transmitter transmitting ultrasonic waves toward an object according to a control signal and an ultrasonic receiver receiving a plurality of reflected waves generated by being reflected from a surface of the object, the operating method comprising:
measuring amplitudes of the plurality of reflected waves at the ultrasonic receiver;
calculating moving distances of the plurality of reflected waves according to arrival times of the plurality of reflected waves;
calculating a reflectance according to the amplitudes of the plurality of reflected waves and the moving distances of the plurality of reflected waves; and
determining a material of the object according to the reflectance.

6. The operating method of claim 5, wherein the amplitudes of the plurality of reflected waves correspond to amplitudes of a plurality of peaks corresponding to the plurality of reflected waves.

7. The operating method of claim 5, wherein the calculating of the moving distances of the plurality of reflected waves comprises:
determining a distance between the ultrasonic sensor and the object according to occurrence timings of a plurality of peaks corresponding to the plurality of reflected waves; and
calculating the moving distances of the plurality of reflected waves based on the occurrence timings of the plurality of peaks,
wherein a moving distance of an i-th reflected wave among the plurality of reflected waves is (2i)×(the distance between the ultrasonic sensor and the object), and wherein i is a natural number.

8. The operating method of claim 5, wherein the calculating of the reflectance comprises:
calculating an i-th partial product, which is a product of an amplitude of an i-th peak among a plurality of peaks corresponding to the plurality of reflected waves and a square of a moving distance of the i-th peak; and
accumulating a plurality of partial products corresponding to the plurality of peaks,
wherein i is a natural number.

9. The operating method of claim 5, wherein the plurality of peaks have values equal to or greater than a predetermined peak threshold.

10. The operating method of claim 5, wherein the determining of the material of the object comprises:
comparing the reflectance with a predetermined material threshold; and
determining the material of the object to be a first material when the reflectance is greater than or equal to the predetermined material threshold, and determining the material of the object to be a second material when the reflectance is smaller than the predetermined material threshold,
wherein the first material is a harder material than the second material.
